(19) United States
(12) Patent Application Publication
(10) Pub. No.: US 2019/0359040 A1
(43) Pub. Date: Nov. 28, 2019

(54) COMPOSITE LIFTGATE WITH A WINDOW INCLUDING AN INTERLOCKING SEAL

(71) Applicant: MATHSON COMPOSITE GROUP LLC, Oakland Township, MI (US)

(72) Inventor: Boney Mathew, Oakland Township, MI (US)

(21) Appl. No.: 16/423,485

(22) Filed: May 28, 2019

Related U.S. Application Data
(60) Provisional application No. 62/676,358, filed on May 25, 2018.

(51) Int. Cl. B60J 5/10; B32B 3/28; B32B 27/08; B32B 9/00; B32B 27/36; B32B 27/30; B60J 10/70; B60S 1/02; H05B 3/86

(52) U.S. Cl. CPC B60J 5/107; B32B 3/28; B32B 27/08; B32B 9/005; B32B 27/365; B32B 2605/006; B60J 10/70; B60S 1/023; H05B 3/86; B32B 2307/412; B32B 2307/302; B32B 27/308

(57) ABSTRACT

A vehicle liftgate includes a main portion comprised of a composite material and defining an opening. A window covers the opening and includes a body extending to a periphery, and having an inner layer, an outer layer, and an intermediate layer. The intermediate layer is comprised of a transparent heat conductive material, and the inner and outer layers are comprised of a transparent polymeric material. A heat generation element is operably connected with the intermediate layer for generating heat to defrost the multi-layered polymeric window. A seal extends about the periphery and is disposed in interlocked relationship with the body to seal the intermediate layer between the inner and outer layers. The inner and outer layers of the body define at least one groove, and the seal includes at least one protrusion disposed within the at least one groove to establish this interlocking relationship.

### CROSS-REFERENCE TO RELATED APPLICATION

This application claims the benefit of U.S. Provisional Application Patent Ser. No. 62/676,358, filed on May 25, 2018, the entire disclosure of which is hereby incorporated herein by reference.

### BACKGROUND OF THE INVENTION

### 1. Field of Invention

The present invention generally relates to a composite liftgate and a window for the composite lift gate.

### 2. Related Prior Art

Composite liftgates for vehicles are well known in the art. One of the current trends in the automobile industry is to lower vehicle weight to help achieve better fuel economy, thus helping to meet fuel economy standards and to offset the higher fuel prices. Liftgates are traditionally made from stamped steel panels that are heavy and have a high tooling cost. Sheet Molding Compound (SMC) is an alternative to steel for the inner and outer panels of the liftgate. Using SMC has several manufacturing concerns related to the material and process. Steel and SMC liftgates have a mass penalty over thermoplastics. There are also styling restrictions with traditional sheet metal components. Thermoplastic composite type materials used for liftgate applications also have difficulty meeting customer performance specifications.

Defrosters for vehicle windows are also well known in the art. Warm air from a vehicle's heating, ventilation, and air conditioning (HVAC) system is typically used to remove fogging, frost, snow, and ice, from a vehicle's windshield and front side windows, hereinafter generically referred to as defrosting. However, routing additional ductwork to carry heated air from the HVAC system to other window surfaces, such as the vehicle's rear window or outside mirrors, has been found to be uneconomical and/or ineffective. Therefore, secondary defrosting systems using resistive heating to defrost rear windows and mirrors have been developed and typically include resistive wires embedded within the glass or resistive circuits printed on an interior surface of the glass. However, defrosting using these methods is non-uniform, as the area around the resistive circuits will heat up first. The printed circuits are also easily damaged by abrasion or cracking, and can impede a driver vision.

Accordingly, there exists a need for a window for a liftgate which is both lightweight, as well as structurally sound enough to meet various load requirements, while also providing improved defrosting and visibility.

### SUMMARY OF THE INVENTION

It is one aspect of the present invention to provide a window for a vehicle, particularly a window for a composite liftgate. The window includes a multi-layered body extending to a periphery and including an inner layer, an outer layer, and an intermediate layer sandwiched between the inner and outer layer. The intermediate layer is comprised of a transparent heat conductive material. At least one heat generation element is operably connected with the intermediate layer for generating heat to transfer to the intermediate layer and defrost the window. A seal extends about the periphery and disposed in interlocked relationship with the body to seal the intermediate layer between the inner and outer layers.

The composite liftgate constructed with a window in accordance with the present invention is lightweight and improves structural and impact strength. The window in accordance with the present invention also provides improved sealing, improved visibility, and easy installation.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a composite liftgate in accordance with one embodiment of the present invention;

FIG. 2 is an exploded view of a base of the composite liftgate made from a plurality of stacked sheets;

FIG. 3 is cross-sectional view of the composite liftgate illustrating the base including a coating and a cover inside a press mold;

FIG. 4 is a perspective view of a long carbon fiber pellet for use in the cover;

FIG. 5 is a perspective view of a short carbon fiber pellet for use in the cover;

FIG. 6 is a fragmentary exploded view of a multi-layered window for the composite liftgate illustrating an intermediate layer sandwiched between an inner and outer layer;

FIG. 7 is a fragmentary cross-sectional view of the multi-layered window illustrating the intermediate layer comprised of a flexible film;

FIG. 8 is a fragmentary cross-sectional view of the multi-layered window illustrating the intermediate layer comprised of a wires and strips or tapes;

FIG. 9 is a front view of the window illustrating a heat generation element operably connected with the intermediate layer;

FIG. 10 is a schematic view of the window illustrating a wireless power transfer unit disposed in communication with the heat generation element;

FIG. 11 is an exploded perspective view of the composite liftgate illustrating a seal extending around a periphery of the window;

FIG. 12 is a front view of the window illustrating at least one groove and at least one protrusion extending continuously about the window and seal to establish an interlocked relationship therebetween;

FIG. 13 is a front view of the window illustrating the at least one groove and the at least one protrusion extending intermittently around the window;

FIG. 14 is a cross-sectional view taken along the lines 14-14 of the composite liftgate in FIG. 1;

FIG. 15 is a schematic view of a method of making the composite liftgate; and

FIG. 16 is a flowchart for the method of making the composite liftgate.

### DESCRIPTION OF THE ENABLING EMBODIMENTS

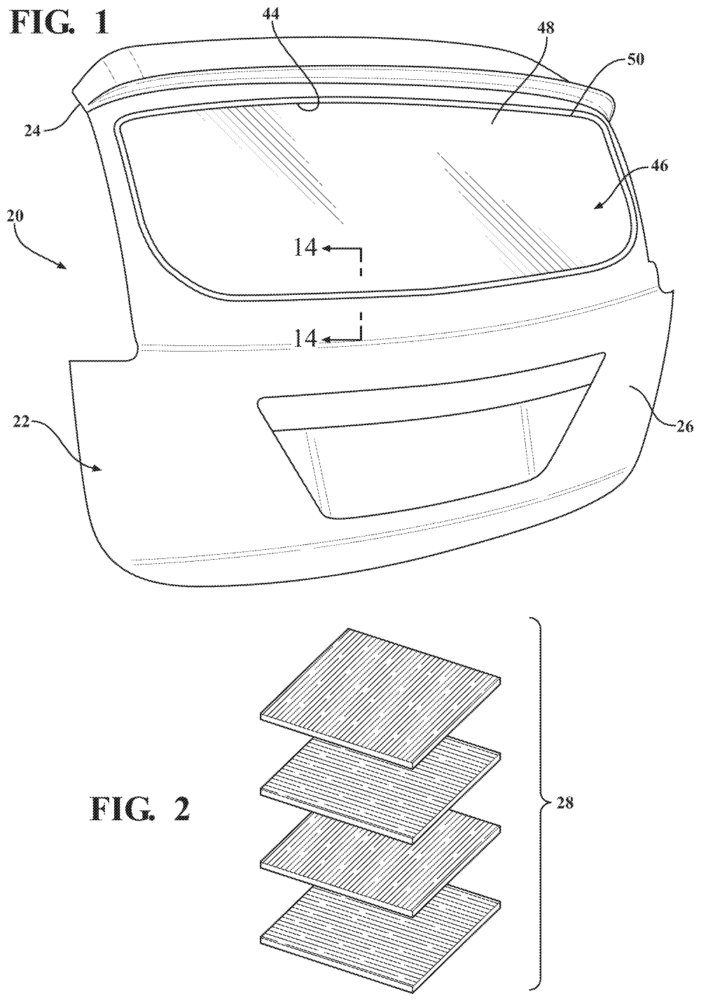

Referring to the Figures, wherein like numerals indicate corresponding parts throughout the several views, a composite liftgate 20 is generally shown in FIG. 1. The composite liftgate 20 includes a main portion 22 comprised of a composite material and having a generally rectangular shape. The main portion 22 has an inner surface 24 for facing an interior of the vehicle and an outer surface 26, disposed opposite the inner surface 24, for facing an exterior of the vehicle. The main portion 22 has a base 28 made from a plurality of stacked sheets. As best shown in FIG. 2, each one of the stacked sheets are made from a plurality of fibers selected from at least one of carbon, aramid, glass, or thermoplastic fibers. In a preferred arrangement, the fibers are a mixture containing carbon and at least one other fiber selected from aramid, glass, or thermoplastic fibers. The fibers are present in an amount of at least 50 vol. % in the main portion 22 to ensure excellent mechanical properties while minimizing weight of composite liftgate 20.

Typically, in each one of the stacked sheets, the fibers are oriented in a single direction. However, as best illustrated in FIG. 2, according to a preferred arrangement, each of the stacked sheets are oriented differently relative to adjacent sheets. More preferably, each one of the stacked sheets is oriented at a ninety-degree angle relative to the adjacent sheets to improve structural and impact strength of the composite liftgate 20.

A coating 30, made from a surface resin, covers and encapsulates the base 28. The surface resin also infiltrates through the base 28, connecting the fibers with one another and joining the stacked sheets with one another, to improve the tensile strength of the composite liftgate 20. The coating 30 preferably contains polyurethane made from a chemical reaction using a first component containing polyol and a second component containing isocyanate. Without being bound by theory, it is believed that the chemical reaction between the polyol and isocyanate forms a primary network and a secondary network. The primary network has a plurality of urethane bonds thereby forming the polyurethane network. The secondary network is a non-covalent hydrogen bonding network thereby providing the coating 30 with a self-heating property.

In an alternative arrangement, the coating 30 contains polyamide made from a chemical reaction using ε-Caprolactam, an activator, and a catalyst. A specific example of a useful polyamide is polycaproamide, also known as Nylon 6 or Polyamide 6. The polycaproamide can be produced by mixing the ε-Caprolactam with the activator and the catalyst and curing the mixture. It should be appreciated that additional additives, such as thickeners and/or compatibilizer, can be added to the mixture as well. Preferably, the polyamide has a melting temperature equal to or above 150° C. to provide good modulus, impact strength, heat resistance, and chemical resistance to the coating 30.

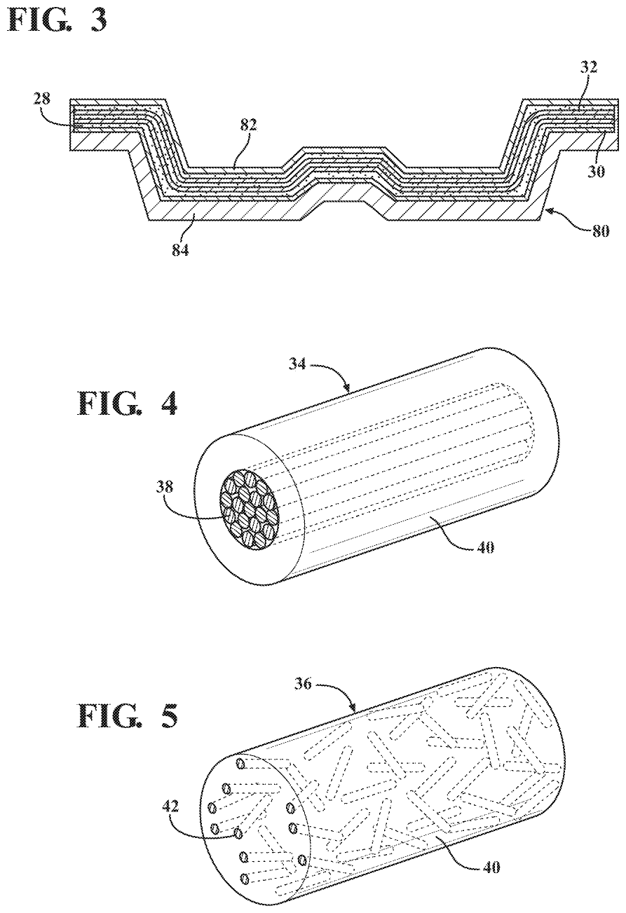

As best illustrated in FIG. 3, the coating 30 can also contain ecologically friendly materials such as acrylic based thermoplastic resin free of styrene. It should be appreciated that the styrene-free coating can be partially derived from biologically renewable resources and recycled materials, all without sacrificing performance. At room temperature, e.g. approximately 20° C., the acrylic based thermoplastic resin has a Brookfield viscosity between 100 cP and 500 cP allowing for excellent impregnation/infiltration into the fibers. In addition, the acrylic based thermoplastic resin can be made from a two component system including polyethylene methacrylate (PMMA) and an initiator. The initiator can be a Luperox® peroxide initiator. Preferably, the acrylic based thermoplastic resin are formed over the base 28 via a resin transfer molding process. The molding temperature during the resin transfer molding process should be approximately 80° C. under a predetermined pressure between 15 psi and 150 psi.

As further illustrated in FIG. 3, the composite liftgate 20 includes a cover 32 bonded to the coating 30 to provide a finish to the composite liftgate 20. The cover 32 is formed from a plurality of pellets 34, 36 containing carbon fiber to provide weight reduction, improve modulus, and enhance impact strength. The pellets 34, 36 can be long carbon fiber pellets 34 or short carbon fiber pellets 36. As best shown in FIG. 4, the long carbon fiber pellets 34 are comprised of a plurality of long carbon fibers 38 being enclosed by a matrix resin 40. Preferably, the matrix resin 38 contains polyamide. The long carbon fibers 38 have an average fiber length of 1.0 mm. As best shown in FIG. 5, the short carbon fiber pellets 36 are comprised of a plurality of short carbon fibers 42 randomly disposed in the matrix resin 38 containing polyamide. The short carbon fibers 42 have an average fiber length of 0.30 mm.

According to another arrangement, the cover 32 is formed from a mixture containing Acrylonitrile Butadiene Styrene (ABS) and Nylon with the ABS providing painting stability and Nylon providing chemical resistance to the cover 32. Accordingly, with the cover 32 being made from a mixture containing ABS and Nylon, it allows users to paint the cover 32 without any primers thereby reducing the manufacturing cost for the composite liftgate 20.

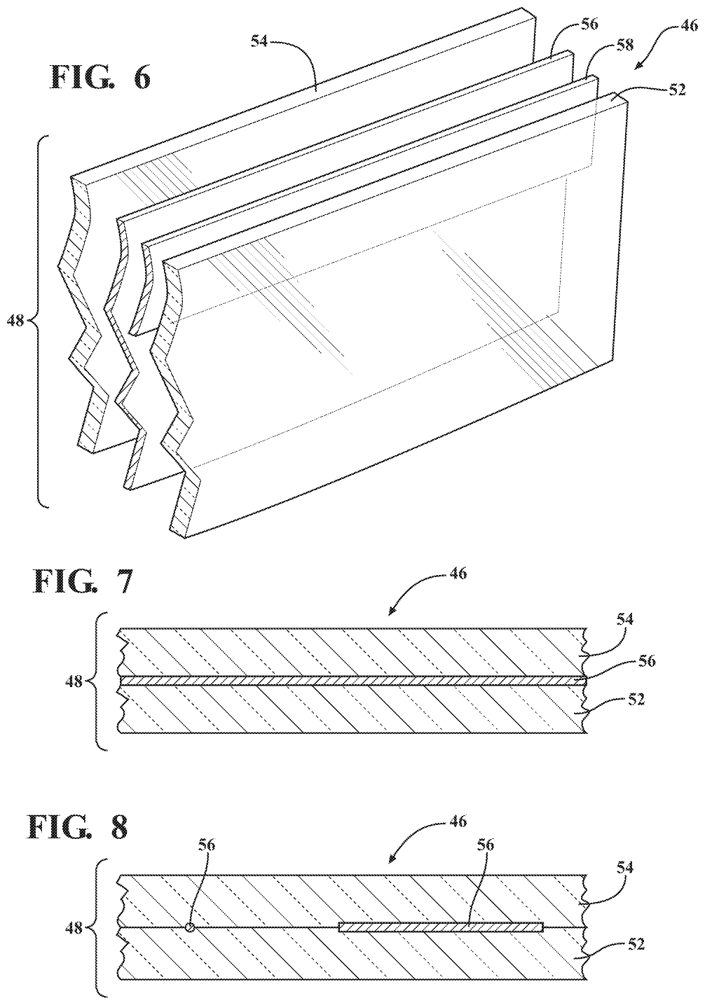

Referring back to FIG. 1, the main portion 22 of the composite liftgate 20 defines an opening 44, having a generally rectangular shape, extending through the cover 32, the coating 30, and the base 28. A window 46 including a body 48, having a generally rectangular shape, attaches to the main portion 22 and covers the opening 44 for allowing a user to see through the main portion 22. The body 48 defines a periphery 50 extending about the body 48. As best shown in FIG. 6, the body 48 of the window 46 is multi-layered, and includes an outer layer 52, an inner layer 54, and an intermediate layer 56 sandwiched between the outer layer 52 and the inner layer 52. The outer layer 52 is disposed adjacent to the exterior of the vehicle. The inner layer 54 is disposed adjacent to the interior of the vehicle. While the window 46 is described herein for use in association with a composite liftgate 20, the window 46 could also be used for other window applications, such as for front and side windows, or a sunroof, of a vehicle, as well as for a helicopter cockpit window, without departing from the subject disclosure.

As illustrated in FIG. 7, in one embodiment, the intermediate layer 56 is a flexible film made from a transparent heat conductive material, preferably, selected from a composite containing graphene and poly(dimethyl siloxane), a composite containing graphene and Poly(3,4,-ethylenedioxythiophene), a composite containing graphene and poly(N-hydroxyl methyl) acrylamide, or Barium Stannate. More preferably, the transparent heat conductive material is the composite containing graphene and poly(dimethyl siloxane) or the composite containing graphene and Poly(3,4,-ethylenedioxythiophene). The graphene and poly(dimethyl siloxane) composites are flexible, foldable and stretchable conducts. The graphene and Poly(3,4,-ethylenedioxythiophene) composites have good solution processability, excellent optical transparency, conductivity and flexibility. Composites containing graphene are preferable for the flexible film because graphene is an excellent electrical conductor due to graphene's chemical structure and nanometric thickness. Graphene is also lightweight and stronger than steel which can be used to reinforce polymers, fiberglass, and carbon fibers. In addition, as a two-dimensional material, graphene displays remarkable optical properties, including a simple transparency for visible light. Further, graphene is hydrophobic which can be used for tailoring special coating in marine, aerospace, and automotive markets.

As illustrated in FIG. 8, in another embodiment, the intermediate layer 56 can be a plurality of wires, strips, or tapes made from a graphene-based composite material or a silver nano-composite sandwiched between the outer layer 52 and the inner layer 54. Alternatively, the intermediate layer 56 can be a ceramic material containing indium tin oxide or a glass coated with indium tin oxide. Yet in another embodiment, the outer layer 52 or the inner layer 54 can include surface mounted non-metallic grids or films (not shown) such as a graphene-based composite material or a silver nano-composite.

The outer layer 52 and the inner layer 54 are comprised of optically transparent polymeric materials. In a preferred arrangement, the inner and outer layers 52, 54 are comprised of Polymethyl Methacrylate (PMMA) or Polycarbonate (PC), namely, because both PMMA and PC have improved impact resistance and lower weight in comparison with the traditional safety glass. More preferably, the outer layer 52 is a transparent material containing PMMA to provide improved ultraviolet resistance and the inner layer 54 is a transparent material containing PC to provide improved impact resistance. Optionally, the outer layer 52 and the inner layer 54 can contain a thermal conductive additive of Polycarbonate/Alumina (Al₂O₃) composites or Polyethylene nanofibers to further improve the thermal conductivity of the outer layer 52 and the inner layer 54. In addition, the outer layer 52 can include a hard coating layer formed thereon by plasma enhanced chemical vapor deposition to improve abrasion and weather resistance.

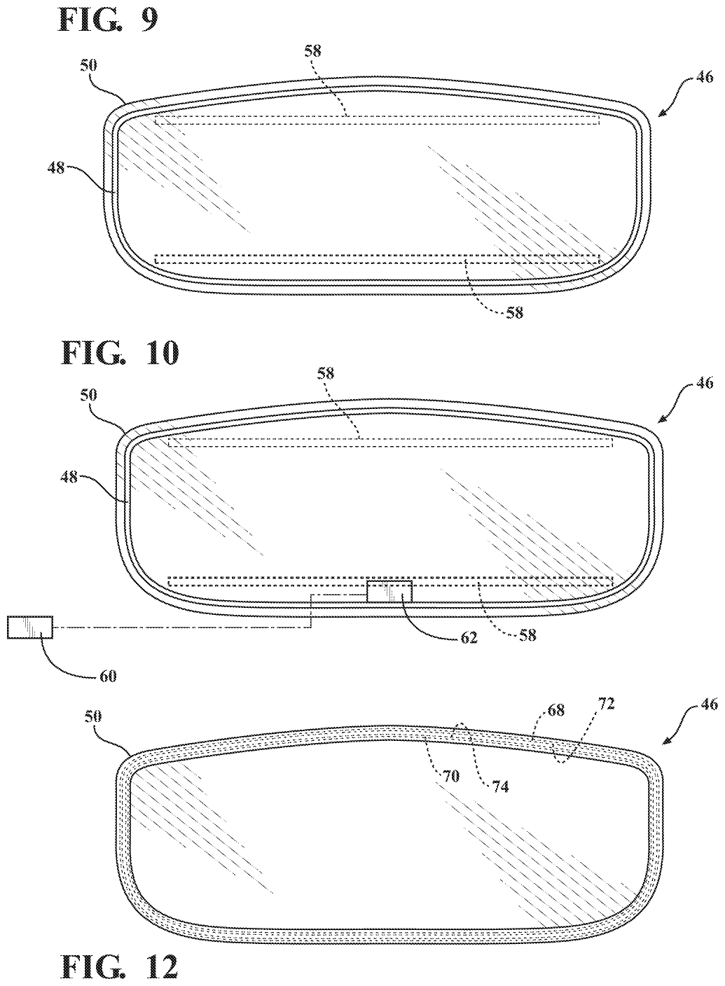

As best show in FIG. 9, at least one heat generation element 58 is operably connected with the intermediate layer 56. For example, the at least one heat generation element 58 is disposed in an abutment relationship with the intermediate layer 56, and thus also disposed between the inner and outer layers 52, 54, for receiving power from a power source and generating heat to transfer to the intermediate layer 56 to defrost the multi-layered polymeric window 46. The at least one heat generation element 58 preferably includes a pair of heat generation elements 58, disposed in opposite and spaced relationship from one another, adjacent to the periphery 50 of the body 48 and in abutment with the intermediate layer 56. The heat generation elements 58 are disposed in electrical communication with a power source which applies a current to the heat generation elements 58. In response, the resistance of the heat generation elements 58 increases the temperature of the heat generation elements 58 to heat up the intermediate layer 56, and then the outer layer 52 and inner layer 54, to defrost the window 46.

As best illustrated in FIG. 10, in one arrangement of the heat generation element 58, the vehicle can include a wireless power transfer unit 60, 62 to supply a current to the heat generation elements 58. The wireless power transfer unit 60, 62 includes an emitter 60 and a receiver 62. The emitter 60 is attached to the interior of the vehicle and the receiver 62 is electrically connected to at least one of the heat generation elements 58. In operation, the emitter 60 generates RF waves to the receiver 62. Upon receiving the RF waves, the receiver 62 converts the RF waves into pockets of energy thereby sending currents through the heat generation elements 58.

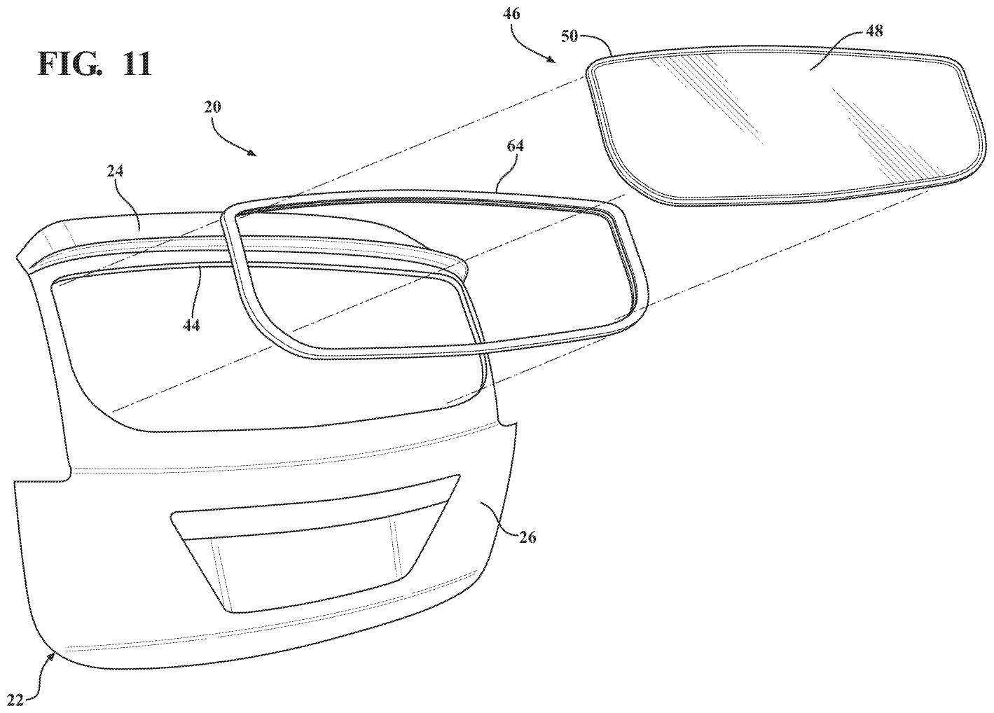

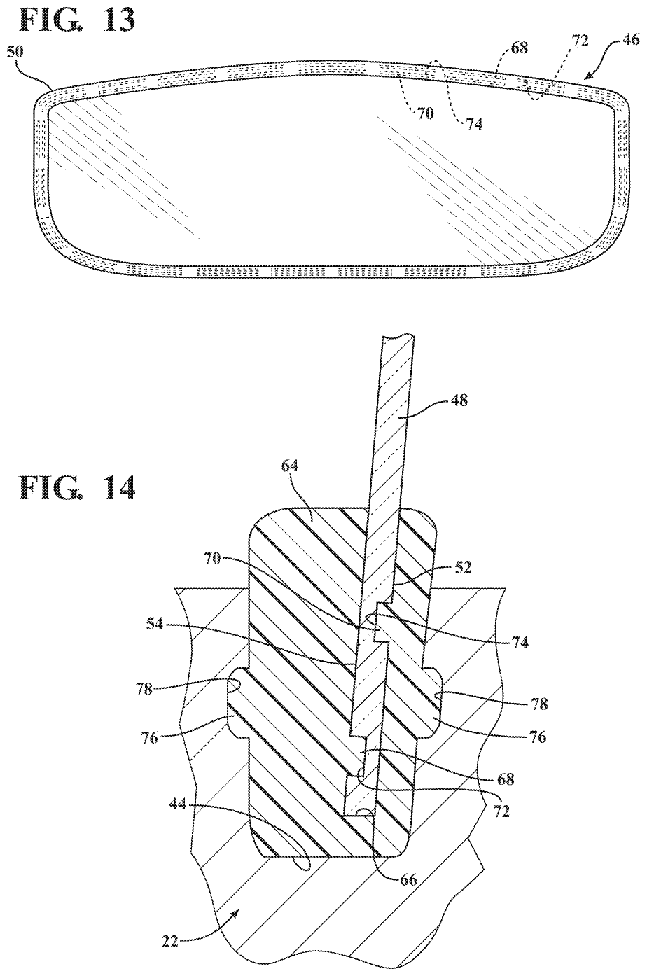

As illustrated in FIG. 11, the window 46 further includes a seal 64 comprised of elastomeric material coupled to and extending about the periphery 50 of the body 48 for sealing the intermediate layer 56, as well as the heat generation element 58, between the outer and inner layers 52, 54. For example, as illustrated in FIG. 14, the seal 64 defines a recess 66 extending along the seal 64 for receiving the body 48 to couple the seal 64 to the body 48 and dispose the seal 64 in an air and water tight arrangement about the periphery 50 of the window 46. The seal 64 is interlocked to the body 48 of the window 46 via a molded or snap-fit connection to allow for an easy installation of the seal 64 onto the body 48 while, at the same time, allowing for close abutment between the seal 64 and the body 48 thereby improving the sealing capabilities. In other words, the seal 64 can be molded on or snapped onto the polymeric window 46 to seal the multiple layers 52, 54, 56. With the seal 64 being disposed about the periphery 50 of the body 48 and in close abutment with the body 48, the interlocked seal 64 prevents dust and/or debris as well as water from entering between the outer layer 52 and the inner layer 54 thereby improving the visibility of the driver.

As best shown in FIG. 14, the seal 64 includes at least one protrusion 68, 70 extending into the recess 66. The body 48 of the window 46 correspondingly includes at least one groove 72, 74 located on the inner layer 54 or the outer layer 52, adjacent and spaced from the periphery 50, for receiving the at least one protrusion 68, 70 to establish the interlocked connection between the seal 64 and the window 46. Preferably, the at least one groove 72, 74 includes a pair of grooves 72, 74 and the at least one protrusion 68, 70 includes a pair of protrusions 68, 70 to provide a stronger and improved molded or snap-fit connection with both of the inner and outer layers 52, 54 of the window 48. In other words, the at least one protrusion 68, 70 and the at least one groove 72, 74 improve the strength of the interlocking connection between the seal 64 and the window 46.

As noted immediately above, the pair of grooves 72, 74 has a first groove 72 and a second groove 74, adjacent and spaced from the periphery 50. The first groove 72 is located on the inner layer 54, adjacent and spaced from the periphery 50, extending about the body 48 and toward the outer layer 52. The second groove 74 is located on the outer layer 52, adjacent to and spaced from the periphery 50, extending about the body 48 and toward the inner layer 54. In other words, the first groove 72 and the second groove 74 are located on opposing surfaces of the body 48 and extending towards one another.

The pair of protrusions 68, 70 has a first protrusion 68 for engaging the first groove 72 and a second protrusion 70 for engaging the second groove 74. The first protrusion 68 extends outwardly from the recess 66 for engaging the first groove 72. The second protrusion 70, spaced from the first protrusion 68, extends outwardly from the recess 66 in a direction opposite of the first protrusion 68 to engage the second groove 74 for securing the seal 64 to the body 48. In other words, the first protrusion 68 and the second protrusion 70 extend towards one another to engage the first groove 72 and the second groove 74, respectively, to establish the interlocked, molded or snap-fit, connection of the seal 64 to the body 48 of the window 46.

As best shown in FIG. 12, in one embodiment, the at least one groove 72, 74 extends continuously about the body 48 and the at least one protrusion 68, 70 extends continuously along the seal 64. In another embodiment, and as best shown in FIG. 13, the at least one groove 72, 74 extends intermittently about the body 48 and the at least one protrusion 68, 70 extends intermittently along the seal 64.

As best illustrated in FIG. 11, the seal 64 also facilitates attachment of the window 46 to the opening 44 of the main portion 22 of the composite liftgate 20. To attach the window 46 to the opening 44 of the composite liftgate 20, the seal 64 includes at least one projection 76 extending outwardly from the seal 64 for engaging the main portion 22. Preferably, the seal has a pair of projections 76 extending radially outwardly from the seal 64 and opposite of one another. The main portion 22 of the composite liftgate 20 defines at least one indentation 78 disposed in the opening 44 of the main portion 22 for receiving the at least one projection 76. Preferably, the main portion has a pair of indentations 78 disposed in the opening 44, extending in a direction opposite of one another, for receiving the pair of projections 76. Additional adhesives can be added into the indentations 78 to facilitate with securing the window 46 and the seal to the opening 44.

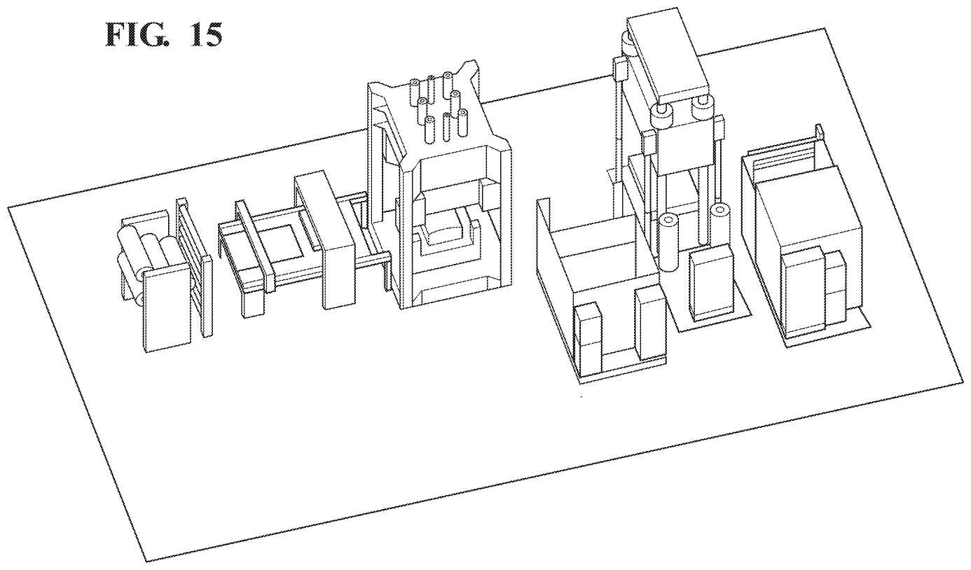

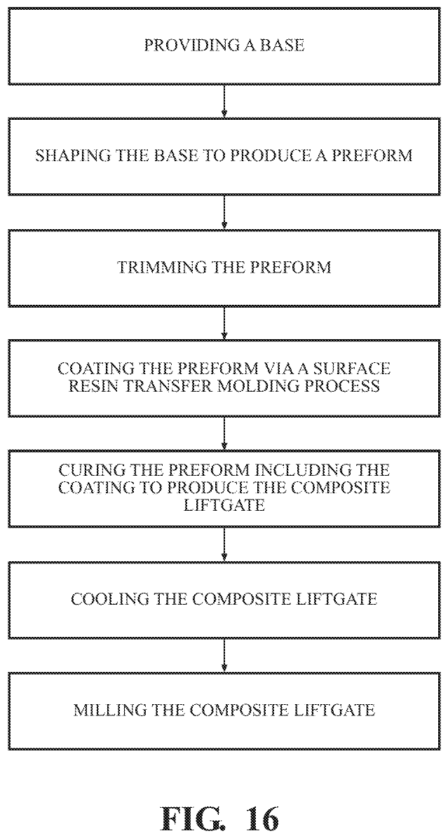

As best illustrated in FIGS. 15 and 16, a method of making the composite liftgate 20 begins by providing a base 28 of the composite liftgate 20. The step of providing the base 28 is defined as stacking a plurality of fiber sheets over one another to produce the base 28. Each one of the fiber sheets can be purchased directly from a manufacturer or, alternatively, manufactured by using fiber filaments. It should be appreciated that, in each one of the stacked sheets, the fibers are preferably oriented in a single direction. As previously described, each one of the stacked sheets are oriented differently relative to the orientation of adjacent one of the stacked sheets, such as, each one of the stacked sheets is oriented at a ninety-degree angle relative to the adjacent one of the stacked sheets, to improve structural and impact strength of the composite liftgate 20.

The method proceeds with a step of shaping the base 28 to produce a preform. The step of shaping is further defined by disposing the base 28 in a preform press and pressing the base 28 to produce the preform. Then, the method proceeds with a step of trimming the preform to remove excess fibers. With reference to FIG. 3, after trimming, the preform is placed into a press mold 80 having a top portion 82 and a bottom portion 84 and a coating 30 formed on the press mold 80 via a surface resin transfer molding process. It should be appreciated that the surface resin transfer molding process is a two-step process. During the first step, a surface resin is introduced into the press mold 80 and infiltrates through the fibers in the preform to form a matrix holding the fibers together. During the second step, after the matrix cures in the press mold 80, the top and bottom portions 82, 84 of the press mold 80 are opened to a predetermined gap width such that the surface of the preform can be flow-coated with an additional coating of the surface resin in the press mold 80. This additional coating layer compensates for any irregularities on the surface of the preform and provides additional reinforcement to the base 28. The surface resin can contain polyurethane, polyamide, or acrylic based thermoplastic resin free of styrene. The thickness of the coating 30 is dependent upon the geometry of the press form and the build-up of the fiber sheets. Typically, the thickness of the coating 30 can range between 0.15 and 0.2 mm.

After the surface resin transfer molding process, the press mold 80 is cured to produce the composite liftgate 20. Following the curing step, the composite liftgate 20 is cooled to prevent warping and ensure dimensional stability. Finally, after cooling, the composite liftgate 20 is milled to remove any excess fiber and resins.

Optionally, the composite liftgate 20 includes a cover 32 bonded to the coating 30 to provide a finish to the composite liftgate 20. The cover 32 can be formed using the long carbon fiber pellets 34 or the short carbon fiber pellets 36 to provide weight reduction, improve modulus, and enhance impact strength. Alternatively, the cover 32 can also be formed from a mixture containing Acrylonitrile Butadiene Styrene (ABS) and Nylon.

In order to bond the cover 32 to the composite liftgate 20, the cover 20 is first formed using a molding process and placed into the press mold prior to placing the preform into the press mold 80. After placing the preform into the press mold 80 including the cover 32, the surface resin transfer molding process is initiated and then, the press mold 80 is cured to form the composite liftgate 20 including the cover 32.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A window for a vehicle comprising:
a body extending to a periphery and including an inner layer, an outer layer, and an intermediate layer sandwiched between said inner and outer layers;
said intermediate layer comprised of a transparent heat conductive material;
at least one heat generation element operably connected with said intermediate layer for generating heat to transfer to said intermediate layer and defrost the window; and
a seal extending about said periphery and disposed in interlocked relationship with said body to seal said intermediate layer between said inner and outer layers.

2. The window as set forth in claim 1, further comprising:
said seal defining a recess for receiving said periphery of said body;
at least one groove defined by said inner or outer layer of said body and disposed in adjacent and spaced relationship with said periphery; and
said seal including at least one protrusion extending into said recess and disposed within said at least one groove to establish the interlocking relationship between said seal and said body.

3. The window as set forth in claim 2 wherein said at least one groove includes a plurality of grooves defined by said inner or outer layers and said at least one protrusion includes a plurality of protrusions extending into said recess and disposed within respective ones of said plurality of grooves.

4. The window as set forth in claim 3, wherein said plurality of grooves includes a first groove defined by said inner layer and a second groove defined by said outer layer; and
said plurality of protrusions include a first protrusion disposed within said first groove and a second protrusion disposed within said second groove.

5. The window as set forth in claim 2 wherein said at least one groove extends continuously along said periphery of said body and said at least one protrusion extends continuously along said seal.

6. The window as set forth in claim 2 wherein said at least one groove extends intermittently along said periphery of said body and said at least one protrusion extends intermittently along said seal.

7. The window as set forth in claim 1, wherein said inner and outer layers are comprised of a transparent polymeric material.

8. The window as set forth in claim 7, wherein said inner and outer layers are comprised of Polymethyl Methacrylate or Polycarbonate.

9. The window as set forth in claim 8, wherein said inner layer is comprised of Polycarbonate and said outer layer is comprised of Polymethyl Methacrylate.

10. The window as set forth in claim 1, wherein said intermediate layer is a flexible film comprised of a composite of graphene and poly(dimethyl silozxane), a composite of graphene and Poly(3,4,-ethylenedioxythiophene) composite, a graphene and poly(N-hydroxyl methyl) acrylamide composite, or Barium Stannate.

11. The window as set forth in claim 1, wherein said intermediate layer is sandwiched between said inner and outer layers and disposed in an abutment relationship with said intermediate layer to establish said operable connection.

12. A liftgate for a vehicle comprising:
a main portion comprised of a composite material and defining an opening;
a window covering said opening and including a body extending to a periphery;
said body including an inner layer, an outer layer, and an intermediate layer sandwiched between said inner and outer layers;
said intermediate layer comprised of a transparent heat conductive material;
at least one heat generation element operably connected with said intermediate layer for generating heat to transfer to said intermediate layer and defrost the window; and
a seal extending about said periphery and disposed in interlocked relationship with said body to seal said intermediate layer between said inner and outer layers.

13. The liftgate as set forth in claim 12, further comprising:
said seal defining a recess for receiving said periphery of said body;
at least one groove defined by said inner or outer layer of said body and disposed in adjacent and spaced relationship with said periphery; and
said seal including at least one protrusion extending into said recess and disposed within said at least one groove to establish the interlocking relationship between said seal and said body.

14. The liftgate as set forth in claim 13 wherein said at least one groove includes a plurality of grooves defined by said inner or outer layers and said at least one protrusion includes a plurality of protrusions extending into said recess and disposed within respective ones of said plurality of grooves.

15. The liftgate as set forth in claim 14, wherein said plurality of grooves includes a first groove defined by said inner layer and a second groove defined by said outer layer; and
said plurality of protrusions include a first protrusion disposed within said first groove and a second protrusion disposed within said second groove.

16. The liftgate as set forth in claim 13 wherein said at least one groove extends continuously along said periphery of said body and said at least one protrusion extends continuously along said seal.

17. The liftgate as set forth in claim 13 wherein said at least one groove extends intermittently along said periphery of said body and said at least one protrusion extends intermittently along said seal.

18. The liftgate as set forth in claim 12, wherein said inner and outer layers are comprised of a transparent polymeric material.

19. The liftgate as set forth in claim 18, wherein said inner and outer layers are comprised of Polymethyl Methacrylate or Polycarbonate.

20. The liftgate as set forth in claim 12 wherein said seal includes at least one projection extending radially outwardly from said seal and said main portion defines at least one indentation disposed adjacent said opening for receiving said at least one projection and mating said window with said main portion.
